(19) United States
(12) Patent Application Publication
(10) Pub. No.: US 2007/0143133 A1
(43) Pub. Date: Jun. 21, 2007

(54) Method and system relating to multilateral customized messaging system for cards, letters and correspondence

(76) Inventor: Andrew Velcoff, Atlanta, GA (US)

Correspondence Address: Andrew Velcoff, 505 Gramercy Drive, Marietta, GA, 30068, US

(21) Appl. No.: 11/642,129

(22) Filed: Dec. 19, 2006

Related U.S. Application Data
(60) Provisional application No. 60/753,002, filed on Dec. 21, 2005.

(51) Int. Cl. G06Q 99/00

(52) U.S. Cl. 705/1

(57) ABSTRACT

Method and system for the creation and mailing of personalized correspondence to specified recipients through an electronic medium. A customer views an interface through an electronic devise wherein the interface displays one of a number of different application for which he/she can use to create custom correspondence. Upon the entry of preferences and receipt of payment, the customer can opt to electronically mail the correspondence or have the correspondence generated and mailed.

### BACKGROUND

1. Technical Field

This disclosure relates to the creation and distribution personalized letters, correspondence, cards, notes, messages and gifts.

2. Background Art

The method and system allows for the creation and distribution of personalized correspondence and gifts. The present disclosure departs from conventional concepts and designs of the prior art, and in doing so provides a method and system which allows for the creation and distribution of custom or personalized correspondence and gifts without the need of writing letters or cards by hand or time consuming procedure purchasing cards, gifts, stationary and stamps.

### SUMMARY OF THE DISCLOSURE

An embodiment of the invention is to overcome the above and other shortcomings of the known arrangements for producing and mailing custom or personalized letters and gifts.

Another embodiment of the invention, is a system and method of receiving customer data and preferences through electronic device and processing the data to create a custom letter or correspondence and/or gift and mailing the letter/gift in accordance with customer preference.

A further embodiment of the invention includes the ability to access the system through a network, electronic system (such as a computer, kiosk or cell phone) so as to create and manage the distribution of personalized correspondence and gifts.

An additional embodiment of the invention is to provide a custom correspondence system through an electronic means whereby the system software reconciles and manages the data inputted so as to produce customized letters or cards created by a customer and thereafter mailed either to the customer or his or her desired recipient.

In one embodiment, the invention recognizes the role of IP connectivity (both wired and wireless networks) plays and will leverage the “real time” capabilities inherent in an IP network to enhance customers letter writing capabilities and give customers instant access to their information.

In a further embodiment, the invention can offer connectivity over any network, wired or wireless.

In one embodiment of the invention, the customer may access the system through web browsers as well as dedicated icons/buttons on the applicable electronic device which may include computer desk tops, blackberry's, PDAs, cell phone menus or other similar means.

In a further embodiment of the invention, the system combines the power and convenience of computers, cell phones, telecommunication devises with the personal touch of handwriting.

Still a further embodiment of the invention allows customers to access an interface or server through an electronic device.

An additional embodiment of the invention is an interface which displays customer choices for letter writing, such as paper, mailing dates and type face.

Another embodiment of the invention is the creation of a secure system which identifies each user and their account through a personally identifiable tool, such as a password, cookie or identifier.

A further embodiment of the invention is a secure section of the service in which a user logs into the system and can access their preferences such as contacts, handwriting, mailing dates and birthdays.

A further embodiment of the invention allows a customer to easily create a personalized letter over the internet or other electronic devise, pay for the letter, note or gift and have the it sent on a specified date.

An additional embodiment of the invention connects any customer (or entity desiring to send personalized letters or notes) to their recipient of choice. As such, the present invention can optimize current technology to easily create personalized correspondence to recipients.

An additional embodiment of the invention includes icons, symbols or buttons that can be used to offer one-click letters and notes to recipients.

Another object of the invention is to provide a personalized system in which a customer can personalize or customize a letter or card by making a series of selections from a user friendly menu displayed on a system.

Still another object of the invention is to provide a letter writing system in which selection screens on the interface or monitor may be provided in several languages for international sales and for sales in ethnic areas domestically.

Another object of the invention is to provide a personalized correspondence system in which a customer can personalize or customize a card, letter or gift by making a series of selections from a user friendly menu displayed on a monitor. The display can be either touch screen or controlled by a key-board.

An additional embodiment of the invention includes the real-time creation, edits and delivery of personalized correspondence.

In one embodiment, the invention allows customers to create and manage their letters and notes thereby drawing upon their preferences to create a bundle of customer benefits including choice (allowing the customer to decide), confidence (security features) and convenience (providing the customer with the ability to create and track his/her customized notes and letters in real time).

An additional embodiment the invention allows a customer to use the system for all of the customer's letter writing choices, including but not limited to paper, mailing date, pre-written letters, sealing wax, signatures, embossments, perfume, handwriting, ribbons, enclosures, color and graphics.

A further embodiment of the invention is access to a form file which will provide form letters or outlines of letters which can be used in the personal correspondence.

An additional embodiment includes the ability to download a photograph to be include in or on the personalized correspondence.

In a further embodiment of the invention, the user sends the selected text and/or graphic (including still photos and/or graphics) to the system along with the name and mailing address of each recipient and further provides credit card billing information.

A further embodiment of the invention allows users to create, order and pay for their customer correspondence over a secure server.

An additional embodiment of the invention, allows the customer to leverage the enhanced security features available with system, such as credit card information, contact information and stylized signatures.

Another embodiment of the invention includes an account set-up which accepts, stores and processes: (i) basic customer information, (ii) basic customer preferences, such as, paper, type or handwriting, personalized signature, recipient information, envelops, delivery methods, graphics, perfume, pre-written notes or letters, cards and jokes, announcements, invitations, thank you notes and cards, special occasion cards and stationary, embossing, ribbons, stationary, pictures, cartoons, inserts (e.g., confetti), customized stamps, gift certificates. CDs, archived letters and text as well as payment information, methods and processing.

A further embodiment of the invention includes a feature which allows for the addition, deletion and maintenance of customer information and preferences.

Another object of the invention is to provide a system capable of producing fully-customized greeting cards, letter, invitations and correspondence in any desired number and in which the recipient's name may be included as well as that of the sender. Specific data such as birth date, age, anniversary date, years married, grade and date graduated, degree obtained, name and kind of pet, type of relative, type of relationship, and the like data may also be included.

A further embodiment of the invention includes the creation a new letter/note writing mechanism which allows customers to a “create” personalized, what looks like hand written correspondence to their recipients.

A further object of the invention is to provide a system for creating and producing custom letters in which available card and letter design formats are displayed to a customer only after entry of specified information relating to the application or use for the product thereby limiting the number of displays to those necessary and appropriate for selection by the customer.

Another object of the invention is to provide a system capable of filling current voids in the cards and letters market by meeting a customer's desire to obtain fully customized cards and letters which express exactly that which the customer wants to convey in their handwriting.

An additional embodiment of the invention allows a customer to pre-order letters, correspondence and/or gifts and directing them to be mailed automatically on a reoccurring basis according to the customer's preference.

In an additional embodiment, the system will showcases customer handwriting or type face as preferred by the customer.

Another embodiment of the invention gives customers handwritten, personal correspondence that reflects their own style and personality.

In one embodiment of the invention the system not only allows customers to create and customize their own letters and notes by choosing the paper, cards, jokes, confetti, inserts, text, ribbons, type or handwriting, pictures, stamps, perfume, graphics, sealers. They also provide pre-written letters or notes to which they can choose from and whether to personalize it or send it as is.

In another embodiment of the invention, the customer will be given the opportunity to electronically review and modify the notes and letters prior to being sent to their specified recipients.

In an additional embodiment of the invention, the system transforms customer text messages and email customized to paper mail.

An additional embodiment of the invention includes a system which creates a realistic handwritten documents or letters to personalize correspondence.

An embodiment of the invention is a stand-alone application for creating personalized letters and notes which began as email, text message or other electronic means.

A further object of the invention is to provide a personalized letter or greeting card producing system in which the customer is able to view the letter or card while being created, line by line, prior to final printing of the card.

Another embodiment of the invention is to allow customers to scan in their own handwriting style or choose a handwriting style which will be applied to their correspondence.

A further embodiment of the invention is to allow a customer to input or email select text which will be converted into a customized letter tailored to the preference of the customer and then mailed to the intended recipient.

An additional embodiment includes means for controlling the reproducing means to produce a customized finished letter or card product on the recording medium in the desired design format and with said additional information appearing at the designated locations on the product.

In one embodiment of the invention, the system will leverage the fraud detection capabilities of payment providers and processors.

An additional embodiment of the invention will leverage against electronic consumer security issues (e.g., ID Theft or contact information theft).

In one embodiment of the invention, the system allows customers to store their contact information and letter style preferences so when they have the information they would like transformed into a personal letter or note they can go to one location (e.g., a website or software interface) and create, pay for and mail their “personalized” letter or note from one location.

Another embodiment of the invention includes the delivery and mailing of the personalized correspondence through a delivery or carrier service.

A further embodiment of the invention offers a set of features and attributes which allows customers, merchants and businesses to meet in one place and create personalized notes and letters.

An additional embodiment of the invention allows for customers and businesses to sell preferred businesses stationary, cards and services.

Still a further embodiment of the invention is the method of collecting user information and letter preferences and creating a personalized letter or correspondence per the preferences of the user and then mailing the correspondence.

The various features of novelty that characterize the invention are pointed out with particularity in the claims annexed to and forming a part of the present disclosure. For a better understanding of the invention, its operating advantages and specific objects attained by its use, reference should be had to the accompanying drawing and descriptive matter in which there are illustrated and described preferred embodiments of the invention.

### BRIEF DISCLOSURE OF THE DRAWINGS

FIG. 1 a schematic representation of the processes carried our by the present method and system.

FIG. 2 a flow chart representing the processes used by the customer when accessing the system.

FIG. 3 is a schematic representation of the operations carried out by the method and system used to create the personalized correspondence.

FIG. 4 is a flow chart representing the processes used by the customer when accessing the system.

### DISCLOSURE OF THE PREFERRED EMBODIMENTS

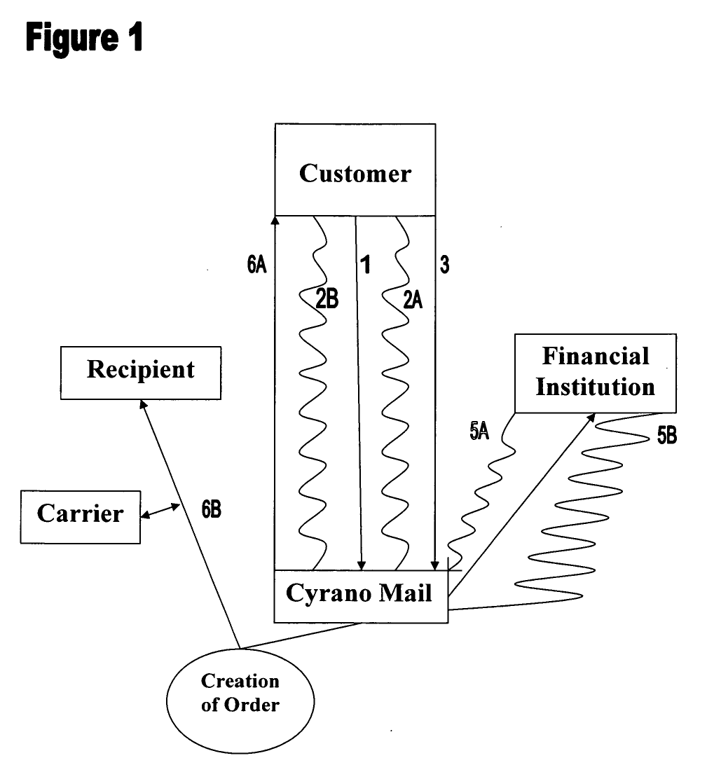

FIG. 1, step 1, the customer electronically accesses the system. In step 2a of FIG. 1, the customer creates an account, storing financial information, handwriting and font preferences, contacts and personal information. In step 2b of FIG. 1, the customer is a returning customer and the system recognizes the customer, providing the customer to his/her account information. In step 3 of FIG. 1, the customer “shops” the system, choosing cards, stationary, gifts or other preferences and thereafter requests to purchase and personalize the items. In step 4 of FIG. 1, the system seeks payment authorization from the relevant financial institution of customer after customer has inputted payment information. In step 5a of FIG. 1, the transaction is approved by the financial institution as within the set of rules and preferences and the approval message is sent back to the system and the customer. In step 5b of FIG. 1, the transaction is rejected by the financial institution as within the set of rules and preferences and the rejection message is sent back to the system and the customer. In step 6a of FIG. 1, the transaction is approved, the items are purchased and created, delivered to the preferred carrier services and subsequently delivered to the recipient. In step 6B of FIG. 1, the transaction is rejected, the items are not created and the customer is not charged.

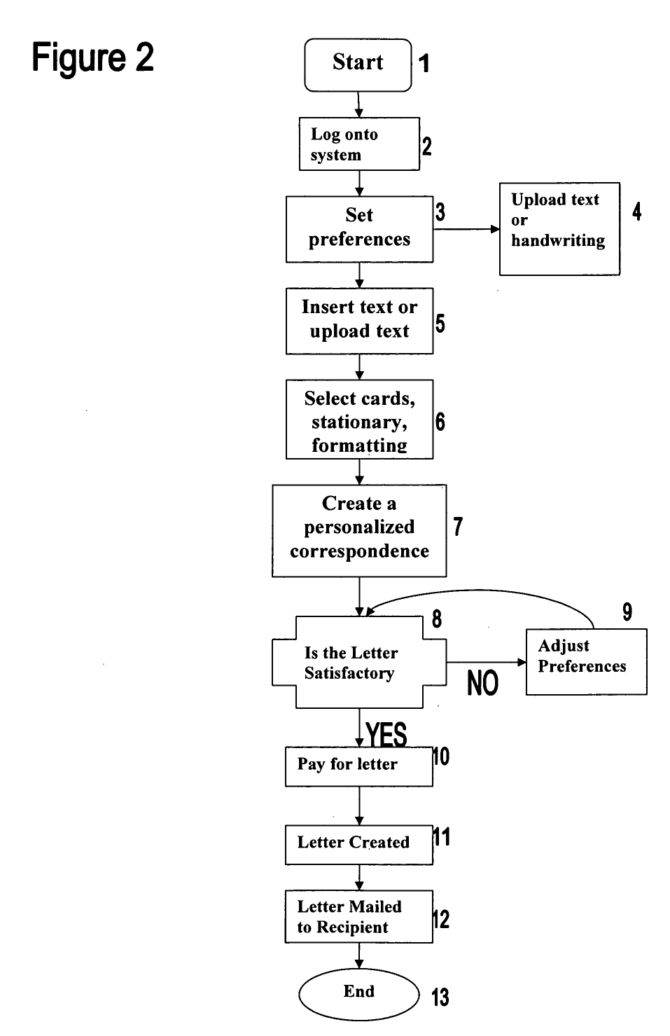

The method and system allows for the creation of custom letters and correspondence through the use of an electronic devise which accesses the system. FIG. 2, sets forth the method in which a personalized correspondence can be created. In FIG. 2: The customer begins the process (1) by logging onto the system through an electronic devise (2). Once on the system the customer sets and accesses his/her preferences, which includes but is not limited to font style, favorite cards and stationary, recipients and reoccurring mailings (3). The customer can also upload or choose his/her signature and handwriting which will be applied to personalized correspondence if chosen by the customer (4). Further the customer can choose from a catalog of for letters or outlines of letters which they can customize as their own correspondence, The customer will then have the option of inputting the text for its personalized correspondence or uploading the text to be applied (5). The customer will then select the formatting, stationary, cards and gifts to be used with the personalized correspondence (6). The system then allows the customer to view the proposed finished product (7). The customer can either edit his/her choices (9) or approve of the correspondence (8). The customer then inputs his/her payment information or promotional codes (10). Once the payment information is approved, the personalized correspondence is then generated (11) and either physically mailed or electronically mailed (12) to the recipient on the date specified by the customer.

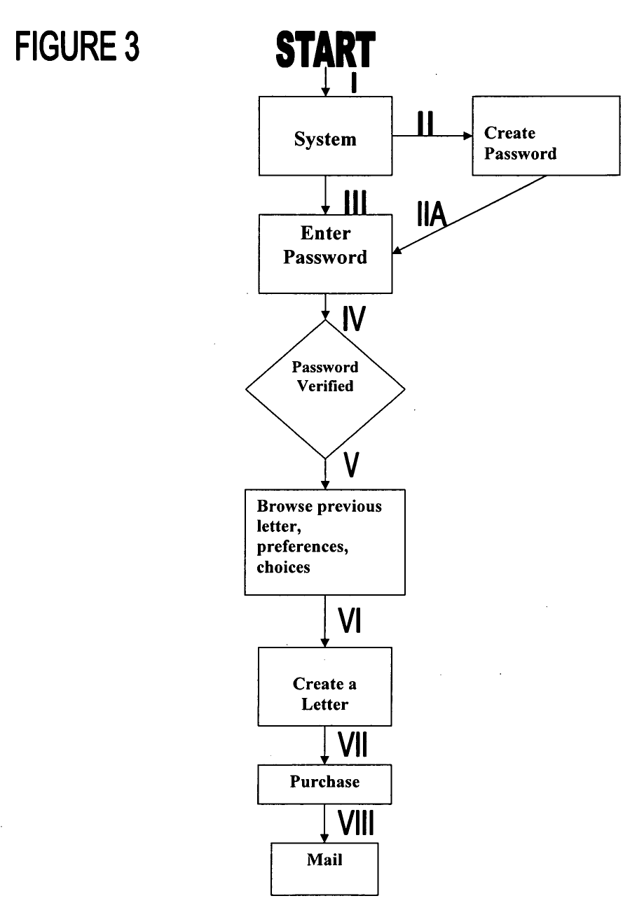

FIG. 3 demonstrated how the method and system can be used to create personalized accounts which can be easily accessed by the customer to speed up the process of creating personalized correspondence. In FIG. 3, the customer logs into the system through an electronic devise (I). The customer views the system through an interface that connects to the system. A first time customer will create a password (II) so that he/she can be identified when they enter onto the system. (IIa). After a customer has the password created he/she will enter it (III) and the system will verify the password (IV) and thereafter allow them to view and set personal preferences, such as (i) basic customer information, (ii) basic customer preferences, such as, paper, type or handwriting, personalized signature, recipient information, envelops, delivery methods, graphics, perfume, pre-written notes or letters, cards and jokes, announcements, invitations, thank you notes and cards, special occasion cards and stationary, embossing, ribbons, stationary, pictures, cartoons, inserts (e.g., confetti), customized stamps, form letters, customizable letters, gift certificates, CDs, archived letters and text as well as payment information, methods and processing (V). Once the customer makes his/her selection for preferences and uploads or inputs selected text, a letter or personalized correspondence is generated for viewing (VI). Once the letter, personalized correspondence and/or gift is electronically generated and approved by the customer, the customer shall pay for the personalized correspondence (VII). After the personalized correspondence, letter or gift is paid for it is either physically generated through a system, printed out and mailed to an intended recipient or electronically generated and electronically mailed to the recipient (VIII).

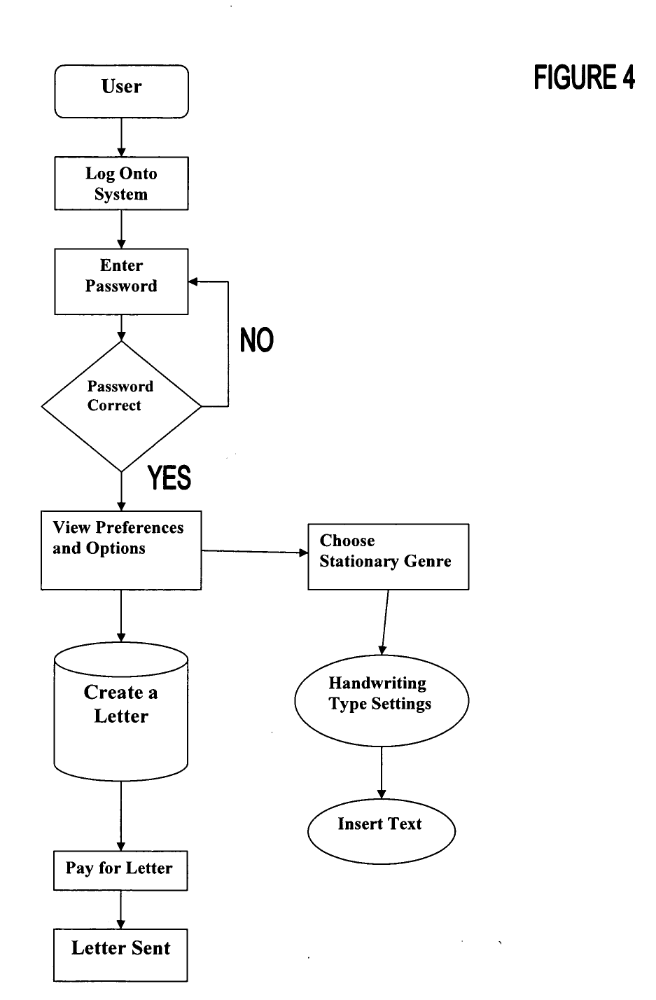

FIG. 4 is a flow chart representing the processes used by the customer when accessing the system. The customer will access the system through an electronic device. The device will display the system interface which connects to the system. The customer will identify himself/herself through a login password. Once the password is verified, the customer enters onto the system and views and/or selected preferences, such as (i) basic customer information, (ii) basic customer preferences, such as, paper, type or handwriting, personalized signature, recipient information, envelops, delivery methods, graphics, perfume, pre-written notes or letters, cards and jokes, announcements, invitations, thank you notes and cards, special occasion cards and stationary, embossing, ribbons, stationary, pictures, cartoons, inserts (e.g., confetti), customized stamps, gift certificates, CDs, archived letters and text as well as payment information, methods and processing. The customer will choose what preferences are applicable and/or make new choices based upon the offerings set forth on the interface. The customer will then input or select text for its customized correspondence. The customized correspondence is electronically generated for viewing by the customer. Once the customer is satisfied with the preview, he/she inputs his/her payment information. After the payments are verified, the custom correspondence is either electronically mailed to a recipient or physically generated via software and mailed to the recipient.

Since many modifications, variations and changes in detail may be made to the present disclosure, it is intended that all matter in the foregoing disclosure or shown in the accompanying drawings be interpreted as illustrative and not in a limiting sense.

What is claimed and desired to be secured by Letters Patent is as follows:

1. A method for creating and forwarding a combination personalized correspondence and related gifts comprising the steps of:
interconnecting a central database and an interactive interface;
displaying a menu of alphanumeric and/or graphic information on the interface from which a customer can select and upload data to be used to personalize correspondence and gifts;
prompting the customer to select data and/or add personal information via a data input means on the interface to create personalized correspondence;
creating personalized correspondence and gifts with personalized data; and
forwarding the personalized correspondence and/or gifts to a recipient.

2. A method as in claim 1, and further including a step of allowing the customer to select a handwriting style to be used on the personalized correspondence.

3. A method as in claim 1, and further including a step of allowing the customer to input and store preferences and intended recipients which can be accessed when logging onto the interface.

4. A method as in claim 1, and further including the step of prompting the customer to select between the alternatives of printing and mailing the personalized correspondence and associated gift or electronically creating and electronically forwarding said personalized correspondence and associated gift to a recipient.

5. A method as in claim 1, and further including a step of allowing the customer to set up a reoccurring creation and mailing of personalized correspondence to recipients.

6. A method as in claim 1, and further including a step of allowing the customer to choose from a catalog of form or pre-written letters and customize said form or pre-written letters.

7. A method as in claim 1, and further including the step of prompting the customer to enter a payment information for said personalized correspondence and associated gift.

8. A method as set forth in claim 4, wherein the production of the personalized correspondence includes printing personalized correspondence on select cards or stationary.

9. A method as set forth in claim 4, wherein the customer is able to preview the layout of the personalized correspondence and approve or edit its contents and formatting prior to being generated.

10. A method as set forth in claim 4, wherein after the personalized correspondence is generated said forwarding step includes the placement of the personalized correspondence in an addressed, stamped envelope and mailed to the recipient on the date specified by customer.

11. A method as in claim 4, wherein said f orwarding step includes electronically mailing said electronic personalized correspondence to recipient for display and/or printing by the recipient.

12. A method as in claim 1, further including a step of viewing and selecting of gifts to be included with said personalized correspondence.

13. A method as in claim 12, wherein after said selection, a customer customizes the personalized correspondence and/or gifts.

14. A method as in claim 12, wherein the personalized correspondence includes a recording, in the customer's own voice, a custom audio message to accompany the personalized correspondence.

15. A system for processing personalized correspondence from an electronic environment comprising:
a first electronic complex;
a second electronic complex;
a communication link interconnecting said first and second electronic complexes;
means within first electronic complex to input, display and store customer information, preferences, recipient information, handwriting and signatures; and
means in which second electronic complex can obtain, transmit and process the first electronic complex contents so as to allow for the generation of personalized correspondence pursuant to the preferences of customer.

16. The system of claim 15, further including the step of allowing the customer to preview and edit the personalized correspondence.

17. The system of claim 15, further including the step of printing the personalized correspondence, applying postage and mailing to customer's specified recipient.

18. The system of claim 15, further including the step of allowing the customer to upload, download or select specified handwriting to be used on the personalized correspondence.

19. The system of claim 15, further including the step where the customer can create personalized correspondence and electronically mail it to its intended recipients.
